(19) United States
(12) Patent Application Publication
(10) Pub. No.: US 2025/0214070 A1
(43) Pub. Date: Jul. 3, 2025

(54) COMPOSITE CATALYST MATERIAL BASED ON RAPID MICROPLASTIC DEGRADATION AND PREPARATION METHOD AND APPLICATION THEREOF

(71) Applicant: Zhejiang Sci-Tech University, Hangzhou (CN)

(72) Inventors: Deyou Yu, Hangzhou (CN); Wenbin Jiang, Hangzhou (CN); Licong Xu, Hangzhou (CN); Shanli Wang, Hangzhou (CN); Minghua Wu, Hangzhou (CN)

(21) Appl. No.: 19/086,139

(22) Filed: Mar. 21, 2025

Related U.S. Application Data
(63) Continuation of application No. PCT/CN2024/093700, filed on May 16, 2024.

(30) Foreign Application Priority Data
Mar. 21, 2023 (CN) 202310291334.8

(51) Int. Cl. B01J 31/16; B01J 37/06; B01J 37/08; C02F 1/78; C02F 101/30

(52) U.S. Cl. CPC B01J 31/1691; B01J 37/06; B01J 37/08; C02F 1/78; B01J 2231/70; C02F 2101/30

(57) ABSTRACT

The invention provides a composite catalyst material and a preparation method and application thereof, and relates to the technical field of water environment treatment. The preparation method comprises the following steps: (1) adding an alkaline aqueous solution into microplastics, and then adding an accelerator for a hydrolysis reaction to obtain a first reaction solution; (2) adding acid into the first reaction solution to adjust pH to be acidic, and then adding ferric chloride for a solvothermal reaction to obtain a second reaction solution; and (3) carrying out post-treatment on the second reaction solution to obtain the composite catalyst material. The invention solves the technical problem of low resource utilization rate of microplastic degradation in the prior art.

### CROSS-REFERENCE TO RELATED APPLICATIONS

This application is a continuation of International Patent Application No. PCT/CN2024/093700 with a filing date of May 16, 2024, designating the United States, now pending, and further claims priority to Chinese Patent Application No. 202310291334.8 with a filing date of Mar. 21, 2023. The content of the aforementioned applications, including any intervening amendments thereto, are incorporated herein by reference.

### TECHNICAL FIELD

The present invention relates to the technical field of water environment treatment, and particularly to a composite catalyst material based on rapid microplastic degradation and a preparation method and application thereof.

### BACKGROUND OF THE PRESENT INVENTION

Plastic is the largest-scale synthetic consumer product in the world, with an annual output of 359 Million tons in 2018. Plastic is the preferred material in many fields because of a light weight, a low cost, easy processing and diverse properties. Despite these considerable advantages, the resulting plastic pollution has affected the environment and human health. Only a few of plastics are recycled every year, and most of waste plastics are landfilled or incinerated. Although energy stored in plastic wastes is partially recycled in a short term by incineration, no economic value is created or the resource consumption of materials cannot be reduced in a long time, and carbon dioxide and other harmful gases are released at the same time. These plastics that are not landfilled or incinerated to degrade are exposed to the natural environment, and the fragmentation of plastic fragments caused by erosion may produce smaller plastic particles, which are namely microplastics and nanoplastics. The microplastics (MPs) are any plastic fragments with a size less than 5 mm, and there is no specific lower limit. According to reports, it is estimated that 1.5 Million tons of MPs are released into the aquatic environment every year, and because of the small size of the microplastics, the microplastics may be ingested by small organisms with a low nutritional level and accumulated in a food chain of ecosystem. The microplastics have been detected in many aquatic species, even in human placentas; and in a new study, scientists found microplastic particles in human blood for the first time. Because of a large number and a small size, the MPs easily enter a human body through the food chain. Therefore, compared with large plastics, the MPs are much more harmful to human beings. A large number of studies show that the MPs may seriously damage the growth and reproduction of organisms, and even lead to death. Therefore, how to remove the microplastics from the water environment has attracted more and more attention.

At present, typical microplastic separation technologies comprise: membrane filtration, coagulation-flocculation, biological and chemical digestion, electrostatic separation, and the like. The shape, size, quality and other factors of the microplastic particles have great influences on the removal effect of the membrane filtration, pores of an ultrafiltration membrane may be blocked, and membrane pollution may be aggravated in severe case, thus deteriorating the removal performance; the coagulation-flocculation, as a traditional water treatment process, has the characteristics of easy operation and low cost, and can effectively remove suspended colloidal particles in water, and it is also proved that the process may be used to remove the microplastics, but there are few literatures to characterize precipitated floccules; and the biological and chemical digestion can efficiently remove the microplastics, but has harsh treatment process and conditions, and a high cost. In addition, microplastic degradation technologies comprise: biodegradation, advanced oxidation process, Fenton reaction, electrochemical and photocatalytic degradation, and the like. However, the microplastics cannot be completely removed by separation and degradation, and because of the low efficiency of these methods and the urgency of microplastic pollution, the research community mainly focuses on realizing an effective chemical reuse/upgrading recycle technology, which is namely a resource recycle technology. In order to achieve sustainable energy supply and low-carbon emission by a reasonable design, chemical recycling will be the most direct and effective way to achieve plastic recycling. The common method of chemical recycling of plastics and microplastics is to depolymerize the plastics and microplastics into oligomers or monomers, and then separate and purify the oligomers or monomers as raw materials for further production and transformation into high-quality products in textile and other industries. The present invention aims at enhancing the resource utilization rate and reducing the toxic and side effects during rapid microplastic degradation, and provides a new method of degradation, removal and resource utilization of microplastics.

### SUMMARY OF THE PRESENT INVENTION

The present invention aims to provide a composite catalyst material based on rapid microplastic degradation and a preparation method and application thereof, so as to solve the technical problem of low resource utilization rate of microplastic degradation in the prior art.

The present invention provides a composite catalyst material and a preparation method and application thereof, and the preparation method comprises the following steps:
(1) adding an alkaline aqueous solution into microplastics, and then adding an accelerator for a hydrolysis reaction to obtain a first reaction solution;
(2) adding acid into the first reaction solution to adjust pH to be acidic, and then adding ferric chloride for a solvothermal reaction to obtain a second reaction solution; and
(3) carrying out post-treatment on the second reaction solution to obtain the composite catalyst material.

Further, in the hydrolysis reaction in the step (1), an addition amount of the microplastics is 0.5 g/L to 50 g/L, the microplastics are one of polyethylene terephthalate, polytrimethylene terephthalate and polybutylene terephthalate, and a particle size of the microplastics is 100 nm to 1000 μm.

Optionally, the particle size of the microplastics is further preferably 25 μm to 250 μm, and further preferably 50 μm to 100 μm. The microplastics are further preferably 2 g/L to 20 g/L, and further preferably 5 g/L to 10 g/L.

Further, in the hydrolysis reaction in the step (1), the alkaline aqueous solution is a NaOH aqueous solution with a NaOH concentration of 10 g/L to 100 g/L; and a temperature of the hydrolysis reaction is 60° C. to 140° C., and the hydrolysis reaction lasts for 30 minutes to 150 minutes.

Main ingredients of the first reaction solution obtained in the step (1) are sodium terephthalate and ethylene glycol, and the first reaction solution contains a small amount of polymers: phthalocyanine quinone (AQDC), ethylene dicarboxylate (DEG), benzene tricarboxylic acid (TMA), and the like, and further contains a trace amount of micromolecules: 1,4-benzenedicarbaldehyde, p-acetamidobenzoic acid, acetic acid, dimethyl ether, and the like.

Optionally, the NaOH concentration is further preferably 40 g/L to 80 g/L, and further preferably 60 g/L to 70 g/L. The temperature of the hydrolysis reaction is further preferably 80° C. to 130° C., and further preferably 100° C. to 120° C. The hydrolysis reaction further preferably lasts for 40 minutes to 100 minutes, and further preferably lasts for 60 minutes to 80 minutes.

Further, in the step (1), the accelerator is a quaternary-ammonium-salt cationic surfactant.

Further, in the step (1), The accelerator is one or more of dodecyl trimethyl ammonium bromide (chloride), dodecyl dimethyl benzyl ammonium chloride, cetyl trimethyl ammonium bromide (chloride), cetyl dimethyl benzyl ammonium chloride and octadecyl dimethyl hydroxyethyl ammonium nitrate.

Further, in the step (2), a molar ratio of the first reaction solution to the ferric chloride is 1: (0.5 to 3); and a temperature of the solvothermal reaction is 100° C. to 300° C., and the solvothermal reaction lasts for 2 hours to 48 hours.

Optionally, the molar ratio of the first reaction solution to the ferric chloride is further preferably 1: (1 to 2), and further preferably 1:1. The temperature of the solvothermal reaction is further preferably 120° C. to 250° C., and further preferably 150° C.

Further, the post-treatment comprises: centrifuging the second reaction solution for solid-liquid separation, washing with DMF and ethanol continuously, and placing the obtained solid in a vacuum drying box; wherein, a temperature of vacuum drying is 50° C. to 150° C., and the vacuum drying lasts for 2 hours to 48 hours.

Optionally, the temperature of the vacuum drying is further preferably 80° C. to 120° C., and further preferably 100° C. The vacuum drying further preferably lasts for 12 hours to 36 hours, and further preferably lasts for 24 hours

The present invention further provides a composite catalyst material prepared by the method above.

The present invention further provides an application of the composite catalyst material in degradation of an organic pollutant in wastewater.

According to the composite catalyst material and the preparation method and application thereof provided by the present invention, a principle of polyester alkaline hydrolysis is used to rapidly degrade the microplastics, and the prepared composite catalyst material is closer to a pure MOF catalyst by adding the accelerator, so that a recycling rate of microplastic degradation is improved, and the composite catalyst can remove the organic pollutant in wastewater by catalytic degradation, thus solving the technical problem of low resource utilization rate of microplastic degradation in the prior art, and being green, environment-friendly, efficient and convenient.

### DESCRIPTION OF THE DRAWINGS

In order to illustrate the technical solutions in the specific embodiments of the present invention or the prior art more clearly, the drawings which need to be used in describing the specific embodiments or the prior art will be briefly introduced hereinafter. Apparently, the drawings described hereinafter are only some embodiments of the present invention, and those of ordinary skills in the art may further obtain other drawings according to these drawings without going through any creative work.

FIG. 1a and FIG. 1b show SEM images of composite catalysts prepared by insufficient filtration without adding an accelerator and prepared by sufficient filtration in Embodiment 1;

wherein, A is the SEM image of the catalyst prepared by insufficient filtration; and B is the SEM image of the catalyst prepared by sufficient filtration.

FIG. 2 shows change curves of residual rates of RhB degradation by separate ozone/catalytic ozone oxidation with time in Embodiment 1.

FIG. 3a and FIG. 3b show SEM images of composite catalysts prepared by adding different accelerators in Comparative Example 1;

wherein, A is the SEM image of the composite catalyst prepared by adding a dodecyl trimethyl ammonium bromide (DTAB) accelerator; and B is the SEM image of the composite catalyst prepared by adding a cetyl trimethyl ammonium bromide (CTAB) accelerator.

FIG. 4 shows an SEM image of a composite catalyst prepared by replacing a first reaction solution with a pure terephthalate solution in Comparative Example 2.

FIG. 5 is a comparison diagram of degradation rates with and without accelerator at different NaOH concentrations under certain degradation time and temperature in Embodiment 2.

FIG. 6 is a comparison diagram of degradation rates with and without accelerator at different degradation temperatures under certain degradation concentration and time in Embodiment 3.

FIG. 7 is a comparison diagram of degradation rates with and without accelerator under different degradation time at certain degradation concentration and temperature in Embodiment 4.

### DETAILED DESCRIPTION OF PREFERRED EMBODIMENTS

The technical solutions of the present invention are clearly and completely described hereinafter with reference to the embodiments. Obviously, the described embodiments are only some but not all of the embodiments of the present invention. Based on the embodiments in the present invention, all other embodiments obtained by those of ordinary skills in the art without going through any creative work should fall within the scope of protection of the present invention.

### Embodiment 1

This embodiment provided a method of rapid microplastic degradation and use of a degradation waste liquid for preparing a composite catalyst material. The method comprised specific steps of: (1) adding an alkaline aqueous solution into microplastics, and then adding an accelerator for a hydrolysis reaction to obtain a first reaction solution; (2) adding acid into the first reaction solution to adjust pH to be acidic, and then adding ferric chloride for a solvothermal reaction to obtain a second reaction solution; and (3) carrying out post-treatment on the second reaction solution to obtain the composite catalyst material.

Taking PET selected as the microplastics in this embodiment as an example, in a rapid microplastic degradation experiment, step (1) specifically comprised that: selected PET microplastics were 0.5 g/L, NaOH was 60 g/L, and no accelerator was added. The alkali liquor and the PET microplastics were mixed and put into a dyeing machine, heated to 100° C. at 3° C./min, and then cooled after thermal insulation for 60 minutes, so as to obtain a first reaction solution. After the treatment, the first reaction solution was taken out, and subjected to filtering-washing-drying-weighing (the unpolymerized PET microplastics were filtered out by suction, and the filtrate was kept, washed with ethanol for 3 times, and washed with deionized water for 3 times), and a degradation rate was calculated.

An experiment of preparing a composite catalyst material by recycling a waste liquid after the microplastic degradation above comprised step (2) and step (3).

The step (2) specifically comprised that: a mixture concentration in the first reaction solution after the degradation was calculated by using the degradation rate. The first reaction solution was added with acid to adjust a pH value to be 3 to 4, added with ferric chloride with the same mole as the first reaction solution, and stirred at a constant temperature of 20° C. to 25° C. for full dissolution, so as to obtain a second reaction solution after the reaction.

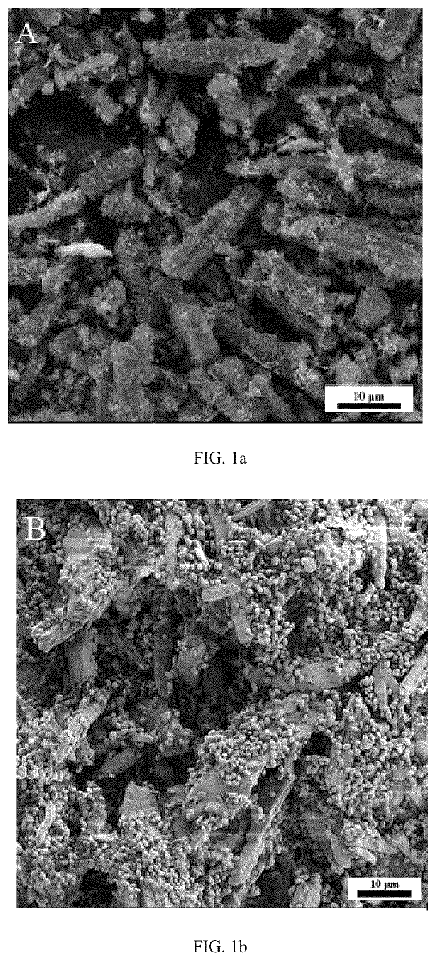

The step (3) specifically comprised that: the second reaction solution was transferred to a stainless steel reaction kettle with a polytetrafluoroethylene lining for a solvothermal reaction at 150° C. for 18 hours. The second reaction solution was centrifuged for solid-liquid separation, and washed with DMF and ethanol for 2 times to 3 times continuously to remove residual raw materials and DMF. Finally, the solid obtained by centrifugal separation was dried in vacuum at 100° C. for 24 hours to obtain the composite catalyst material obtained by recycling. The obtained composite catalyst material was mainly needle-like in morphology, and there were flocculent oligomer residues on a surface of the catalyst prepared by insufficient filtration, while a large number of particles were coated on the surface of the catalyst prepared by sufficient filtration, which were suspected to be ferric oxide formed by oxidization, as shown in FIG. 1a and FIG. 1b.

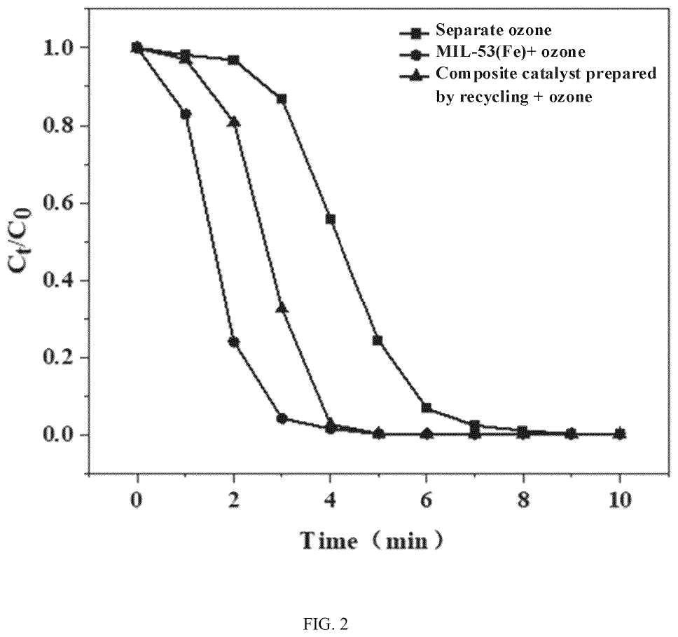

The obtained composite catalyst material could be used to catalyze ozone to degrade an organic pollutant in wastewater. An experimental process for testing a degradation performance was that: 300 mL of 40 mg·L⁻¹ Rhodamine B (RhB) solution was prepared and placed in a wide-mouth glass reactor, and then added with 100 mg of composite catalyst prepared by recycling the wastewater after the PET microplastic degradation, and 5 mL of sample was taken after adsorption and desorption equilibrium for 30 minutes, and started to be introduced with ozone gas at a flow rate controlled to be 60 mL·min⁻¹, so as to start catalytic ozone oxidation for a RhB degradation reaction. During degradation, 5 mL of sample was taken every 1 minute, filtered by a 0.45 μm water-based filter, and then allowed to stand, and then a RhB concentration was measured. Ozone molecules and other ROS in the residual sample were quenched with 0.1 mol·L⁻¹ Na₂S₂O₃ solution to eliminate the persistent effect of the residual ozone and ROS, which affected experimental results. As a control, separate ozone was also carried out under the same experimental conditions, but no catalyst was added to the degradation system. Taking ratios of sample concentration Cₜ to initial RhB concentration C₀ at time points of 0 minute, 1 minute, 2 minutes, 3 minutes, 4 minutes, 5 minutes, 6 minutes, 7 minutes, 8 minutes, 9 minutes and 10 minutes as an ordinate and taking the time points as an abscissa, a diagram of change curves of residual rates of RhB degradation by separate ozone/catalytic ozone oxidation with time was drawn, and taking the degradation rate as an index and taking the performance of separate ozone oxidation as a control, the catalytic activity of the catalytic ozone oxidation system was evaluated. Results were as shown in FIG. 2.

An absorbance of the sample (RhB solution) was measured by an ultraviolet-visible spectrophotometer at λ=554 nm (the maximum absorption wavelength of the RhB solution), and a concentration of the sample RhB was calculated by a Beer-Lambert's Law. The degradation rate (C₀-Cₜ) could be calculated by the following formula:

$$\frac{{C}_{t}}{{C}_{0}} \times 100 \% = \frac{{A}_{t}}{{A}_{0}} \times 100 \%$$

wherein, Cₜ was a concentration of the RhB solution at a moment t; C₀ was an initial concentration of the RhB solution; Aₜ was an absorbance of the RhB solution at the moment t, and A₀ was an initial absorbance of the RhB; and (C₀-Cₜ)/C₀ was a degradation rate of the RhB at the moment t.

It could be seen from FIG. 2 that, in the stage of catalytic ozone oxidation of the RhB, the degradation rate in the first 1 minute to 2 minutes was limited by the solubility of gaseous ozone molecules, that was, the oxidative degradation of the RhB was related to the mass transfer (dissolution) ability of gaseous O₃ molecules in water, and after this stage, the concentration of the RhB changed obviously with the extension of time, and the degradation of the RhB in the separate ozone system could be completed in about 8 minutes; time for realizing complete degradation by a pure MIL-53 (Fe) MOF catalyst was 3 minutes to 4 minutes; and time for realizing complete degradation by the composite catalyst material prepared by recycling the wastewater after the PET microplastic degradation was also about 4 minutes.

### Comparative Example 1

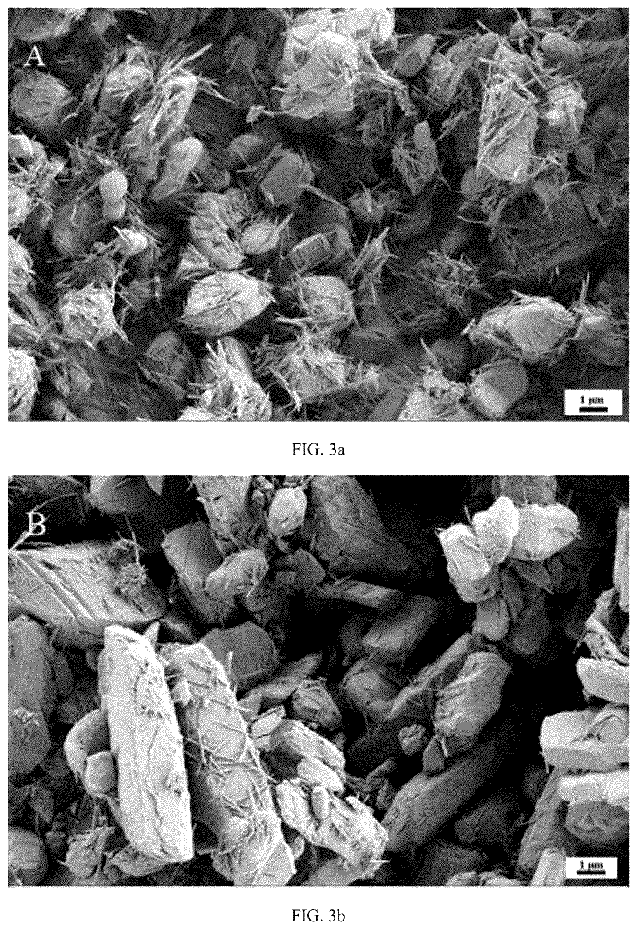

As experimental controls of the rapid microplastic degradation and the use of the degradation waste liquid for preparing the composite catalyst material in Embodiment 1, different accelerators were added to obtain a plurality of first reaction solutions in the step (1). Under the same experimental conditions, the morphologies of the composite catalyst materials prepared respectively were similar to rectangular and rhombic blocks, and there were needle-like substances formed by the accelerators on surfaces of the catalysts, as shown in FIG. 3a and FIG. 3b.

### Comparative Example 2

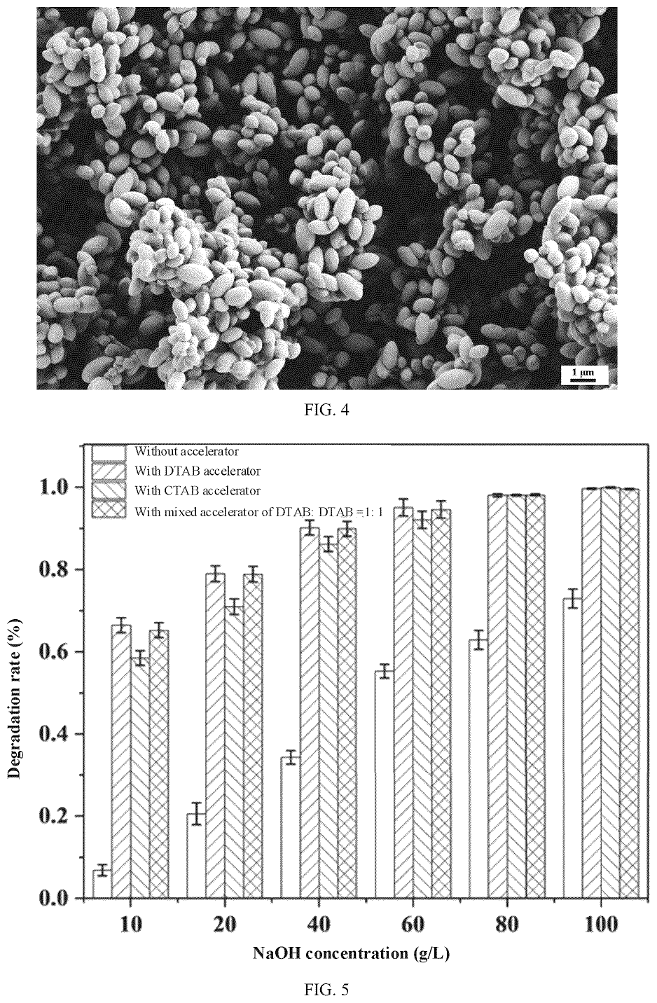

As an experimental control of the rapid microplastic degradation and the use of the degradation waste liquid for preparing the composite catalyst material in Embodiment 1, the first reaction solution in the step (1) was replaced with terephthalate. Under the same experimental conditions, the morphology of the composite catalyst material prepared was as shown in FIG. 4.

It was concluded by comparison that: the composite catalyst prepared by adding the accelerator was closer to the pure MOF catalyst, thus improving the resource utilization rate of microplastic degradation. The comparison of effects of different accelerators showed that the dodecyl trimethyl ammonium bromide (DTAB) accelerator had the fastest degradation rate to PET and the highest resource utilization rate; and because of a short molecular chain of the DTAB accelerator, bromine atoms in the structure promoted the decomposition of PET.

### Embodiment 2

A method of rapid microplastic degradation comprised steps as follows: selected fixed PET microplastics were 5 g/L, a NaOH concentration was adjusted to be 10 g/L, 20 g/L, 40 g/L, 60 g/L, 80 g/L and 100 g/L, and no accelerator was added. As 3 controls, under the same experimental conditions, accelerators of 1.5 g/L dodecyl trimethyl ammonium bromide (DTAB), 1.5 g/L cetyl trimethyl ammonium bromide (CTAB) and a mixture of DTAB and CTAB in a ratio of 1:1 were added respectively. The solution and the PET microplastics were mixed and put into a dyeing machine, heated to 100° C., and cooled after thermal insulation for 60 minutes, so as to obtain a first reaction solution.

After the treatment, the first reaction solution was taken out, the PET was filtered out, and the filtrate was washed with ethanol for 3 times and washed with deionized water for 3 times, and then dried and weighed, and a degradation rate was calculated. In the case of adding different concentrations of NaOH, degradation rates without accelerator and with different accelerators were as shown in FIG. 5. It could be seen from FIG. 5 that the degradation rate was increased with the increase of NaOH concentration; and when the NaOH concentration was 60 g/L or above, the degradation rate with accelerator could reach above 95%.

### Embodiment 3

A method of rapid microplastic degradation comprised steps as follows: selected fixed PET microplastics were 5 g/L, a NaOH mass concentration being 60 g/L was taken as an example, and no accelerator was added. The solution and the PET microplastics were mixed and put into a dyeing machine, a temperature was changed to 30° C., 60° C., 90° C., 100° C. and 120° C., and the temperature was reduced after thermal insulation for 60 minutes, so as to obtain a first reaction solution. As controls, under the same experimental conditions, accelerators of 1.5 g/L dodecyl trimethyl ammonium bromide (DTAB), cetyl trimethyl ammonium bromide (CTAB) and a mixture of DTAB and CTAB in a ratio of 1:1 were added.

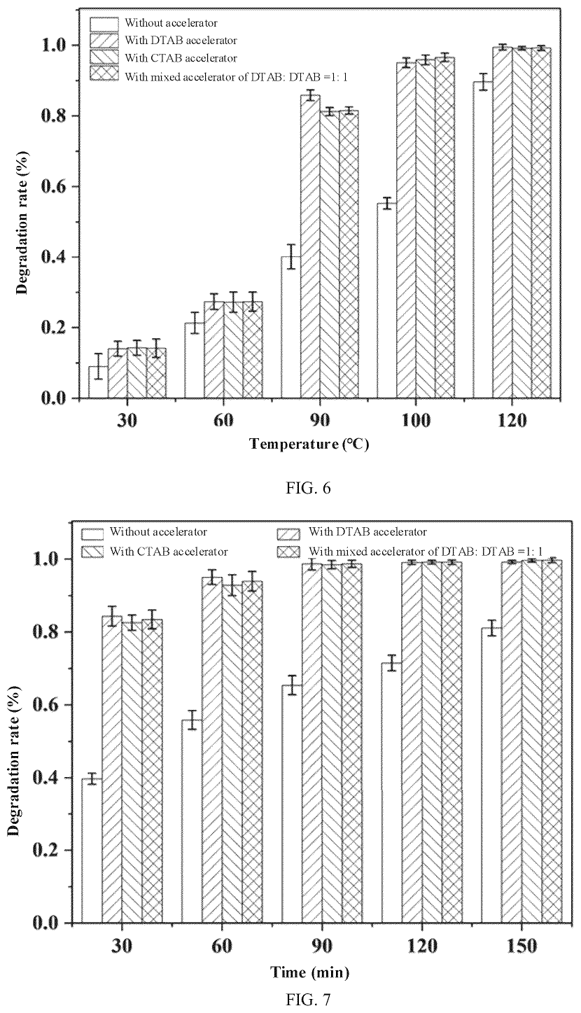

After the treatment, the first reaction solution was taken out, the PET was filtered out, and the filtrate was washed with ethanol for 3 times and washed with deionized water for 3 times, and then dried and weighed, and a degradation rate was calculated. In the case of degradation at different temperatures, degradation rates with and without accelerator were as shown in FIG. 6. It could be seen from FIG. 6 that the degradation rate was increased with the increase of temperature. After the accelerator was added at 100° C., the degradation rate could reach above 90%. It could be seen from FIG. 6 that the degradation rate was increased with the increase of temperature. The degradation rate reached above 90% after the accelerator was added at 100° C.

### Embodiment 4

A method of rapid microplastic degradation comprised steps as follows: selected fixed PET microplastics were 5 g/L, a NaOH mass concentration was 60 g/L, and no accelerator was added. The solution and the PET microplastics were mixed and put into a dyeing machine, and heated to 100° C. with changes at time points of 30 minutes, 60 minutes, 90 minutes, 120 minutes and 150 minutes, so as to obtain a first reaction solution. As controls, under the same experimental conditions, accelerators of 1.5 g/L dodecyl trimethyl ammonium bromide (DTAB), cetyl trimethyl ammonium bromide (CTAB) and a mixture of DTAB and CTAB in a ratio of 1:1 were added.

After the treatment, the first reaction solution was taken out, the PET was filtered out, and the filtrate was washed with ethanol for 3 times and washed with deionized water for 3 times, and then dried and weighed, and a degradation rate was calculated. In the case of degradation at different time points, degradation rates with and without accelerator were as shown in FIG. 7. It could be seen from FIG. 7 that the degradation rate was increased with the increase of temperature. Without accelerator, the degradation rate could not exceed 80% with the increase of time, and with accelerator, the degradation rate could reach above 85% at the time point of 30 minutes.

Although the preferred embodiments of the present invention have been described, those skilled in the art can make additional changes and modifications to these embodiments once they know the basic inventive concepts. Therefore, the appended claims are intended to be interpreted as including the preferred embodiments and all the changes and modifications that fall within the scope of the present invention.

The above specific embodiments are used to explain the present invention, are only preferred embodiments of the present invention, and are not intended to limit the present invention. Any modification, equivalent substitution, improvement, and the like made to the present invention within the spirit of the present invention and the scope of protection of the claims fall within the scope of protection of the present invention.

We claim:

1. An application of a composite catalyst material based on rapid microplastic degradation in catalysis of an organic pollutant in ozone degradation wastewater, wherein a preparation method of the composite catalyst material based on rapid microplastic degradation comprises the following steps:
(1) adding an alkaline aqueous solution into microplastics with a particle size of 100 nm to 1000 μm, and then adding an accelerator for a hydrolysis reaction to obtain a first reaction solution;
wherein, the microplastics are polyethylene terephthalate;
the accelerator is a quaternary-ammonium-salt cationic surfactant, and the accelerator is one or more of dodecyl trimethyl ammonium bromide, dodecyl trimethyl ammonium chloride, dodecyl dimethyl benzyl ammonium chloride, cetyl trimethyl ammonium bromide, cetyl trimethyl ammonium chloride and cetyl dimethyl benzyl ammonium chloride;
the alkaline aqueous solution is a NaOH aqueous solution with a NaOH concentration of 10 g/L to 100 g/L; and a temperature of the hydrolysis reaction is 60° C. to 140° C., and the hydrolysis reaction lasts for 30 minutes to 150 minutes; and
main ingredients of the first reaction solution are sodium terephthalate and ethylene glycol, and the first reaction solution further comprises a small amount of phthalocyanine quinone, ethylene dicarboxylate and benzene tricarboxylic acid, and further comprises a trace amount of 1,4-benzenedicarbaldehyde, p-acetamidobenzoic acid, acetic acid and dimethyl ether;
(2) adding acid into the first reaction solution to adjust pH to be acidic, and then adding ferric chloride solid powder for a solvothermal reaction to obtain a second reaction solution; and
(3) carrying out post-treatment on the second reaction solution to obtain the composite catalyst material.

2. The application according to claim 1, wherein, in the hydrolysis reaction in the step (1), an addition amount of the microplastics is 0.5 g/L to 50 g/L.

3. The application according to claim 1, wherein, in the step (2), a molar ratio of the first reaction solution to the ferric chloride is 1: (0.5 to 3); and a temperature of the solvothermal reaction is 100° C. to 300° C., and the solvothermal reaction lasts for 2 hours to 48 hours.

4. The application according to claim 1, wherein the post-treatment comprises: centrifuging the second reaction solution for solid-liquid separation, washing with DMF and ethanol continuously, and placing the obtained solid in a vacuum drying box; wherein, a temperature of vacuum drying is 50° C. to 150° C., and the vacuum drying lasts for 2 hours to 48 hours.
